(19) United States
(12) Patent Application Publication
(10) Pub. No.: US 2015/0006253 A1
(43) Pub. Date: Jan. 1, 2015

(54) POLLING QUESTIONS SERVED WITH SUPPLEMENTAL INFORMATION

(71) Applicant: 1WORLD ONLINE, INC., SAN JOSE, CA (US)

(72) Inventors: Alexei FEDOSSEEV, San Jose, CA (US); Bradley KAYTON, Hollis, NH (US)

(21) Appl. No.: 14/319,409

(22) Filed: Jun. 30, 2014

Related U.S. Application Data
(60) Provisional application No. 61/840,935, filed on Jun. 28, 2013.

(51) Int. Cl. G06Q 30/02

(52) U.S. Cl. CPC G06Q 30/0203
USPC 705/7.32

(57) ABSTRACT

Structured comprehensive polls are comprised of question and answer options and are supported by expert opinions and data points (subjective and objective information). Structured polls enable interested parties to conduct social research and obtain and analyze information about public opinion based on informed choices and crowd-sourcing applied to information collection and research based on 2-way communication with the target audience.

### CROSS-REFERENCE TO RELATED APPLICATIONS

This application claims priority to U.S. Provisional Application No. 61/840,935, filed Jun. 28, 2013, which is incorporated by reference as though fully included herein.

### TECHNICAL FIELD

This application relates generally to online polling, and more specifically to providing polling questions with supplemental information.

### BACKGROUND OF THE INVENTION

Within Internet and online venues and digital properties, what are known to many as Mature Web 2.0 and Big Data services, we are now transitioning to a new level of understanding that information built and shared via social and professional networks needs to be more credible and representative in order to be useful. In particular, there is unmet demand to obtain accurate, quantifiable and comprehensive data on what people really think about various topics in their life and issues in their world. As an example, to optimally plan development and sales for any product or service it is imperative for merchandisers and marketers to best understand customers' views on product features, service appeal, trends, pricing, as well as have reliable, measurable insight into consumer interests and their decision-making processes. The same is true for analysts in every other area of human life, including politics, culture, sports, entertainment, estimates of geographical, educational and vocational trends, etc.

There is therefore an unmet need for online polling and surveys that can yield more nuanced results while also gauging consumers' reaction to different information underlying particular issues.

### SUMMARY OF THE INVENTION

A polling method and system is presented to create and conduct polls that present questions supported by intelligent, informed opinions and in return generate high quality, reliable and quantifiable results that reflect the true attitude of the audience towards the topic of the poll. This goal is accomplished by supporting polls with supplemental information, which may include both subjective and objective information sources relevant to the content of the polls.

In one embodiment, the techniques may be realized as a method comprising the steps of presenting users with a poll, the poll comprising a plurality of poll options, with the ability for the user to vote for at least one of the poll options, one or more objective information sources associated with the poll options, with the ability for the user to provide an evaluation of each of the one or more objective information sources, and one or more subjective information sources associated with the poll options, with the ability for the user to provide an evaluation of each of the one or more subjective information sources; and aggregating the users' votes of the poll options, the users' evaluations of the one or more objective information sources, and the user's votes of the one or more subjective information sources to generate multi-dimensional poll results.

In accordance with other aspects of this embodiment, the method may include categorizing the poll results based on whether the users' votes correlate with their evaluation of the objective and subjective information sources.

In accordance with other aspects of this embodiment, the one or more objective information sources may include, for each of the poll options, an associated piece of numerical or narrative data that supports the poll option.

In accordance with further aspects of this embodiment, the user may be presented the option of voting for each of the pieces of data. The presentation of each of the pieces of numerical or narrative data may include a total number of times that the piece of data has been voted for.

In accordance with other aspects of this embodiment, the one or more subjective information sources may include, for each of the poll options, an associated expert opinion that supports the poll option.

In accordance with another embodiment, the techniques may be realized as a method comprising the steps of presenting users with a poll, the poll comprising a plurality of poll options, with the ability for the user to vote for at least one of the poll options, and one or more information sources associated with the poll options, with the ability for the user to provide an evaluation of each of the one or more information sources; and aggregating both the users' votes of the poll options and the users' evaluations of the one or more information sources, to generate multi-dimensional results.

In accordance with other aspects of this embodiment, the method may further include categorizing the poll results based on whether the users' votes correlate with their evaluation of the one or more information sources.

In accordance with other aspects of this embodiment, the one or more information sources may include, for each of the poll options, an associated piece of numerical or narrative data that supports the poll option.

In accordance with other aspects of this embodiment, the one or more information sources may include, for each of the poll options, an associated expert opinion that supports the poll option.

In accordance with other aspects of this embodiment, the user may be presented the option of voting for each of the one or more information sources.

In accordance with other aspects of this embodiment, the user may be presented the option of voting either for or against each of the one or more information sources.

In accordance with other aspects of this embodiment, the presentation of each of the one or more information sources may include a score representing an aggregate evaluation of the information sources by users taking the poll.

In accordance with other aspects of this embodiment, the poll may be generated from a data structure including the plurality of poll options and supplemental data associated with each of the poll options. Fewer than all of the supplemental data associated with each of the poll options may be presented as the one or more information sources.

In accordance with further aspects of this embodiment, the poll may include a reference to the supplemental data that is not presented in the poll.

In accordance with another embodiment, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In accordance with another embodiment, the techniques may be realized as a system comprising one or more processors communicatively coupled to a network; wherein the one or more processors are configured to carry out any and all of the steps described with respect to any of the above embodiments.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is an illustration of a structured poll in accordance with embodiments of the present invention.

FIG. 1A is a further illustration of a portion of the structured poll in FIG. 1, expanded according to the user's selection.

FIG. 2 is a table representing multiple dimensions of results in accordance with embodiments of the present invention.

FIGS. 3A-3C are different displays showing polling results broken down along various demographic dimensions in accordance with embodiments of the present invention.

FIG. 4 is a block diagram illustrating a poll question data structure in accordance with embodiments of the present invention.

FIG. 5 is a flow chart illustrating a method for presenting a structured poll in accordance with embodiments of the present invention and receiving user's responses to the presented options.

### DETAILED DESCRIPTION

The present invention relates to methods and systems to create and conduct polls that present questions supported by intelligent, informed opinions and in return generate high quality, reliable and quantifiable results that accurately reflect the attitude of the audience towards the topic of the poll. This goal is accomplished by supporting polls with supplemental information, which may include either or both of expert opinions and related, potentially fact-checked, data points that form a triad system of information where the sum of the parts is more than whole in terms of comprehension of the topic being presented to the recipients, content reliability, and thoroughness of the issues surrounding the topic or topics.

As described herein, the term “poll” is understood to encompass one or more questions, each question being presented to a user in order to elicit a response. The nature of the response may vary widely; in some implementationss, multiple options are presented and the user is expected to select one (or, in some implementations, one or more) of the presented options. Any user behavior in response to a poll, including a partial answer or non-answer, may be recorded as a user response.

As described herein, the term “supplemental information” is understood to encompass information relevant to the poll question beyond that which is necessary to ask the question itself “Supplemental information” is broadly categorized into subjective and objective information, distinguished by whether the information is generally understood to represent a qualitative opinion (such as, for example, an expert opinion or narrative on the topic) or a quantitative fact (such as, for example, numerical data). A variety of information sources may exist for providing supplemental information for a polling question. The examples of supplemental information used herein are not exhaustive and are not intended to limit the scope of supplemental information that may be supplied in accordance with different embodiments of the invention.

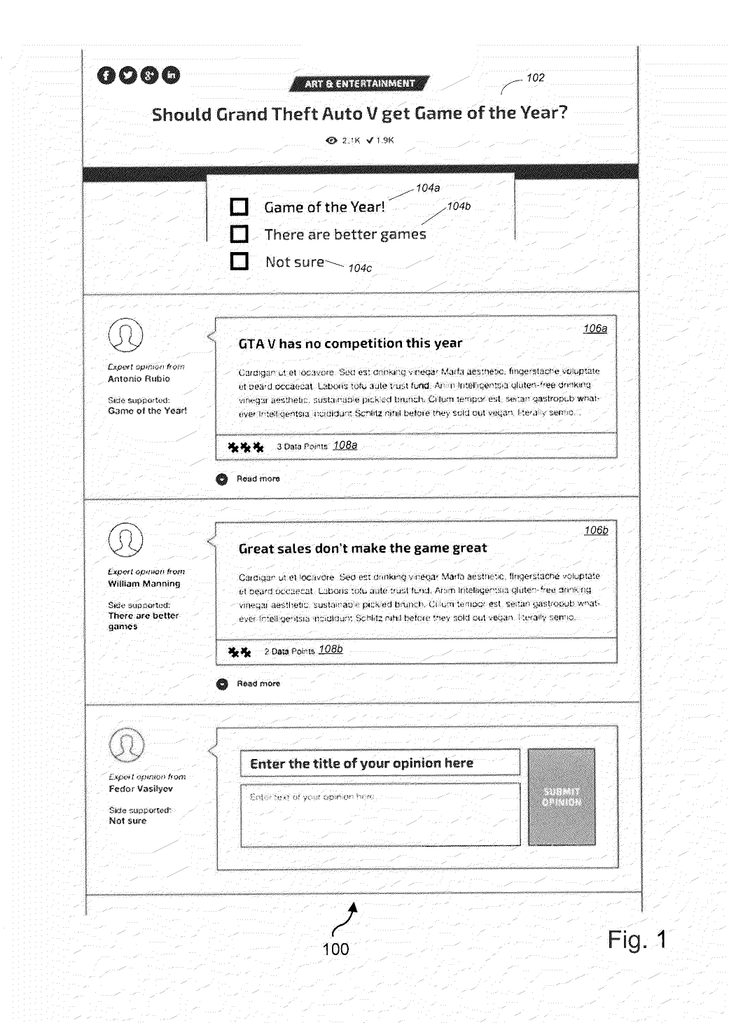

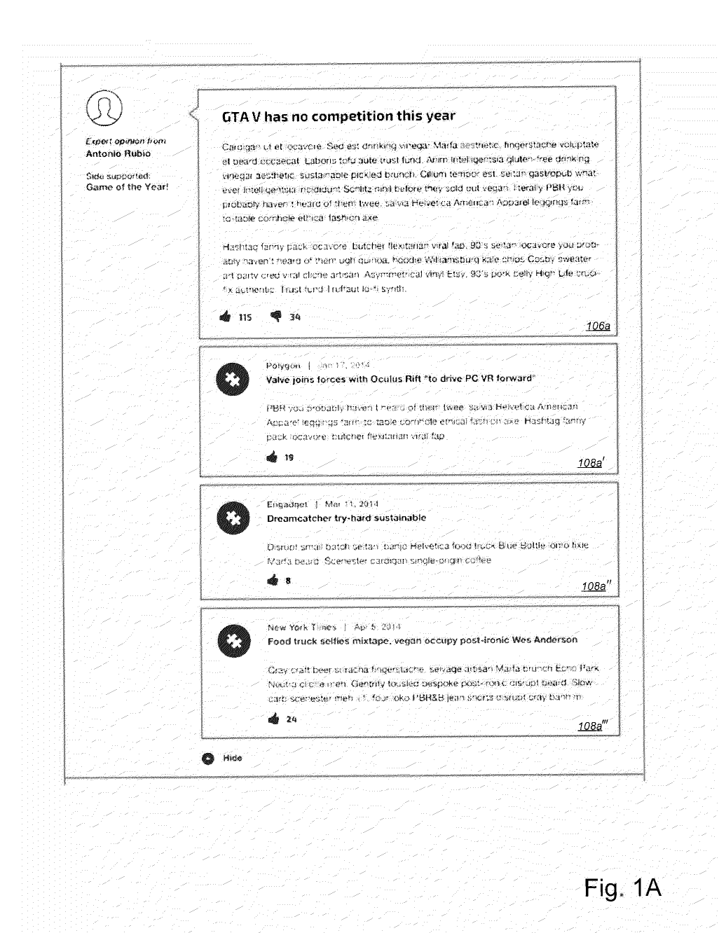

FIG. 1 shows an example of a comprehensive poll 100 with supplemental information. In some embodiments, when a user is exposed to a structured poll 100, the first thing that he or she sees is a tagline and an image designed to attract the user's attention and to present the topic of the poll (the question 102). These can be supported by an optional description which briefly summarizes the topic of the poll 100. The purpose of the description is to make clear the topic of the poll 100.

As illustrated in FIG. 1, the poll 100 includes a question 102 with three potential responses 104a, 104b and 104c. Responses 104a and 104b have associated expert opinions 106a, 106b and associated quantitative data 108a, 108b supporting their associated user poll question response 104a, 104b.

The question associated with the comprehensive poll may include both a short form or title, and a longer description that provides more details about the nature of the question. Although the term “question” is used, it will be understood that any issue or subject that can be resolved by more than one response chosen by a user may be the subject of the poll; there is no limit to literal questions. Responses can range from a simple “yes” vs. “no” to a list of possible answers that are framed as free form sentences and not limited to any particular format.

In some implementations, each expert opinion may be an article composed by a person participating as an expert in the subject matter that is discussed in the poll to which it belongs. The article or other contribution by the expert may not have been written specifically for use in the poll but instead may be curated from some other source; if so, the curation process should be such as to correctly associate the article or fact within the article or data source as providing support for the particular response that the expert opinion is associated with.

The comprehensive poll 100 is presented online and may be delivered to a user via a variety of channels, such as through an internet browser or dedicated application, and may be represented on different types of display devices. The medium of display may have some effect on the extent of the presentation to the user. For example, as shown in FIG. 1, each expert opinion 106a, 106b may be represented by a short excerpt. A user may be able to follow a provided reference (such as a hyperlink) from the presented excerpt to the article source.

As shown, two of the sides of the debate have associated quantitative data 108a, 108b: three pieces associated with the response 104a and two pieces with the response 104b. Each individual piece of quantitative data may be understood to be a reference to an information source and may be expressed in a concise and factual matter to facilitate the understanding of the topic of the poll by the audience. The summary presented on the poll 100 may also include a reference to the underlying information source that may more thoroughly explain the origin of the data and put it into further context. Each may be comprised of a title, the information source reference and an annotation. An information source is typically a web site or any other type of publication. A reference to it could be a URL of the web site or details of the publication data, such as author, publisher, publication, pages, date, etc. An annotation may present a brief description of the information contained within the source. As shown in FIG. 1, the quantitative data 108a, 108b may not be presented to the user as part of the abbreviated display of the front page but may be accessed by the user electing to “Read More.”

FIG. 1A represents a section of the poll 100 that may be expanded by a user selecting “Read More” on the front page, as shown. Here, the expert opinion 106a is fully expanded, and the three Data Points 108a′, 108a″, and 108a′″ representing the quantitative data 108a are also shown.

After the user has studied expert opinions and data points, he or she will be able to make a more educated choice regarding the poll topic and select one of the available responses. By providing supplemental data supporting each of the available options, selections made by the polled audience may be more informed, and the poll itself may act to help educate the audience in a novel and unique manner. This has the benefit of more accurate data input via better responses to the poll questions by from more informed voters.

In order to more comprehensively evaluate user response, the poll 100 provides multiple avenues by which a user can respond to the poll. The user can submit a response by selecting one of the potential responses 104a, 104b, or 104c to the question 102, as shown in FIG. 1. Further, as shown in FIG. 1A, the user can “like or dislike” each of the expert opinions 106a, 106b. The user can also “thumbs-up vote” each of the provided quantitative data pieces. Allowing users to evaluate the supplemental data allows for further analysis of audience opinion, as well as providing a feedback as to whether expert opinions and data sources were considered persuasive and credible.

The poll 100 may show current results representing user responses, including both selections of the answers to the poll question 102 and ratings for each of the provided pieces of supplemental information 106a, 106b, 108a, 108b. These results may present the aggregate of all user responses as well as breaking out user responses into particular groups, sorted by a variety of factors such as demographics. However, the poll itself may continue to associate the results of each user together, thus allowing for more comprehensive analysis of user response.

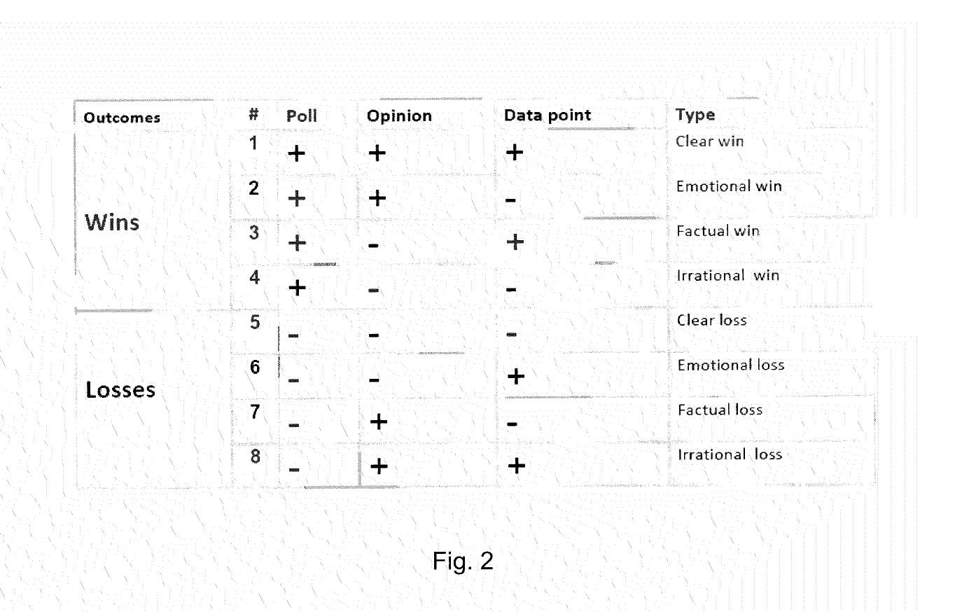

The comprehensive poll 100 and the opportunities for user response provide a variety of data that can have a variety of differing results, as illustrated in the chart 200 of FIG. 2. Most directly, a “win” and “loss” can be established based on which response was selected the most often. However, the particular nature of a “win” or “loss” may be further articulated by means of the users' responses to the supplemental information.

FIG. 2 details eight possible outcomes of the voting process, based on the correlation between the users' answer to the question and the users' response to the supplemental information. The titles given each of these results are descriptive, and in many cases represent only one way that the data may be interpreted.
1. Clear win. The side that received most votes but also the most “likes” for its expert opinion and the most “+1s” for its data points. This is a straightforward situation where the users can make a decision because they agree with the expert's opinion and find the data point informative and relevant to the poll in question.
2. Emotional win. In this case one side receives the most votes on the strength of the personal opinion of the users and/or the expert. Users choose the side even though they don't find the data points convincing or relevant enough.
3. Factual win. Users disagree with the expert opinion or dislike it but the facts presented in the data points can't be denied and they agree with the data points.
4. Irrational win. Users disagree with the expert's opinion and with the data points and yet they choose this particular side of the debate.
5. Clear loss. A simple case where the side loses because users disagree with both the expert's opinion and the data points.
6. Emotional loss. The users agree with the data presented in the data points but vote against the side because they strongly disagree with the expert's opinion.
7. Factual loss. The users agree with the expert's opinion and yet they vote against the side because they are not convinced by the data.
8. Irrational loss. The users agree with both the expert's opinion and the data points and yet they vote against the side.

Poll results that can be quantified in such a unique 3-dimensional way will provide a wealth of information for the analysis of the data and will help to understand the decision making process of the audience as a whole, sub-groups of the audience, or individuals of the audience. Some examples might include a commercial company or an organization running such a poll and observing an emotional or factual win in a controversial debate. Results of this sort of poll may also explains why a target audience accepts or rejects a new product or service not because of declared features and pricing but rather because of a psychological barrier, skewed perception, or other unexpected audience attitude that is very important to measure and understand.

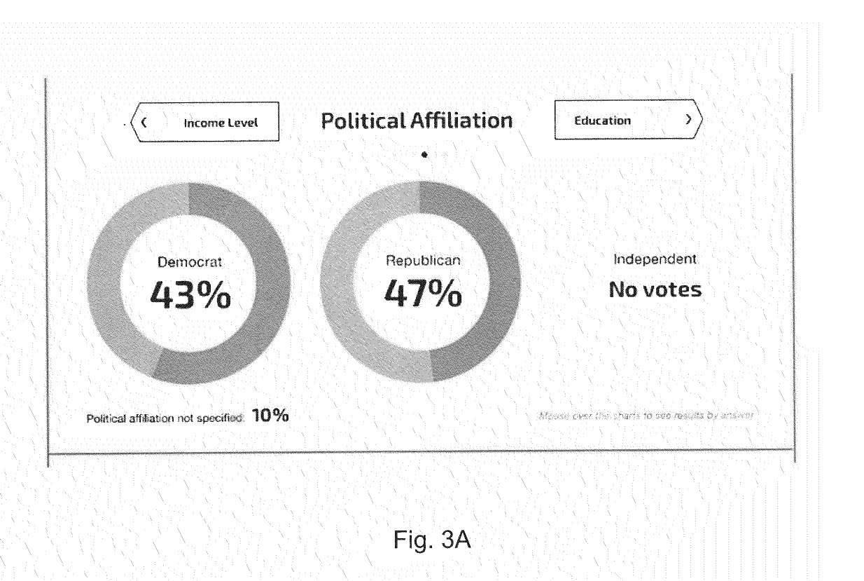

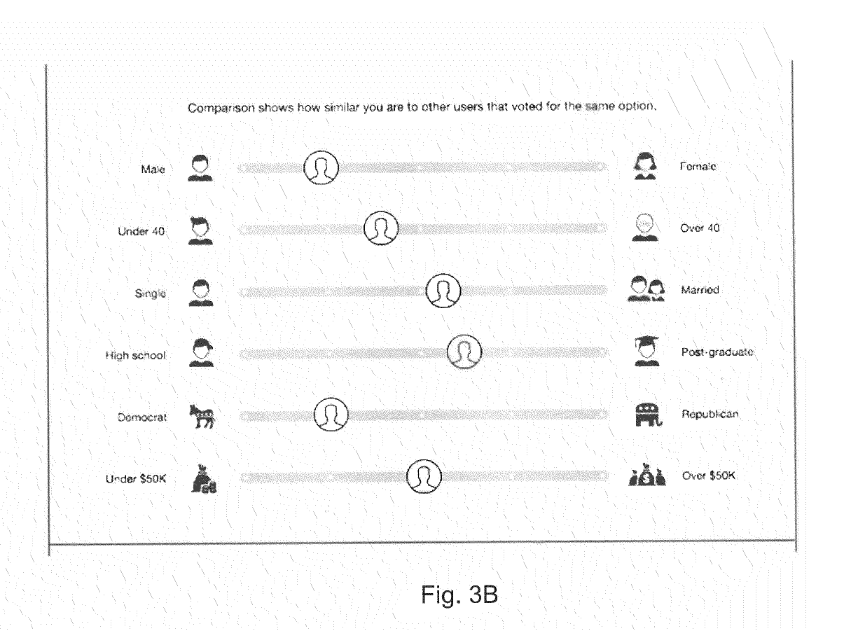

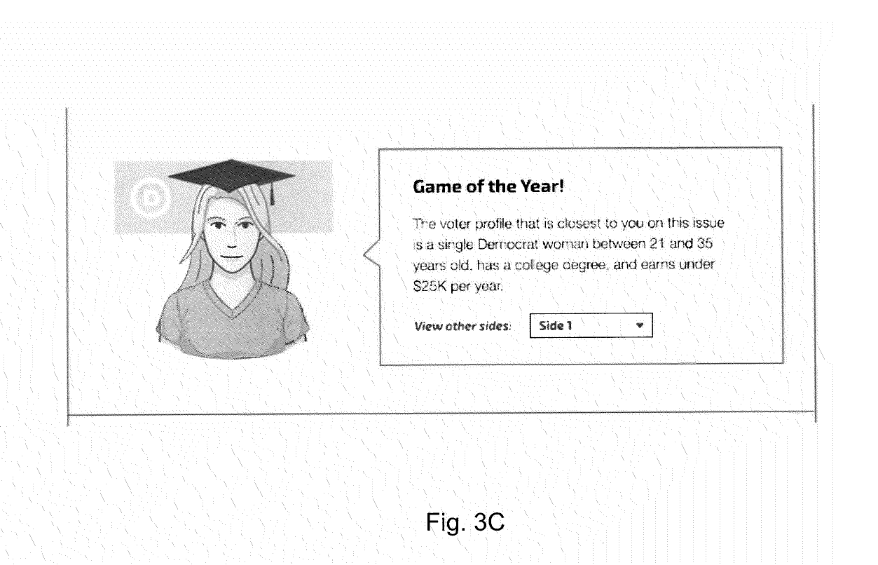

FIGS. 3A-3C show additional information that may be provided either to consumers or to the managers of a poll; in some implementations, the webpage such as the page 100 may even include this information once a user has voted. FIG. 3A shows a breakdown of voters' political affiliation. FIG. 3B shows how a particular user's vote placed the user relative to other voters on the same question, via a variety of demographic factors, including gender, age, marital status, education, political affiliation, and income. FIG. 3C identifies the voter profile that is closest to a particular vote on this issue. By identifying aspects of a user's response with additional demographic information, further refinement of the data is possible.

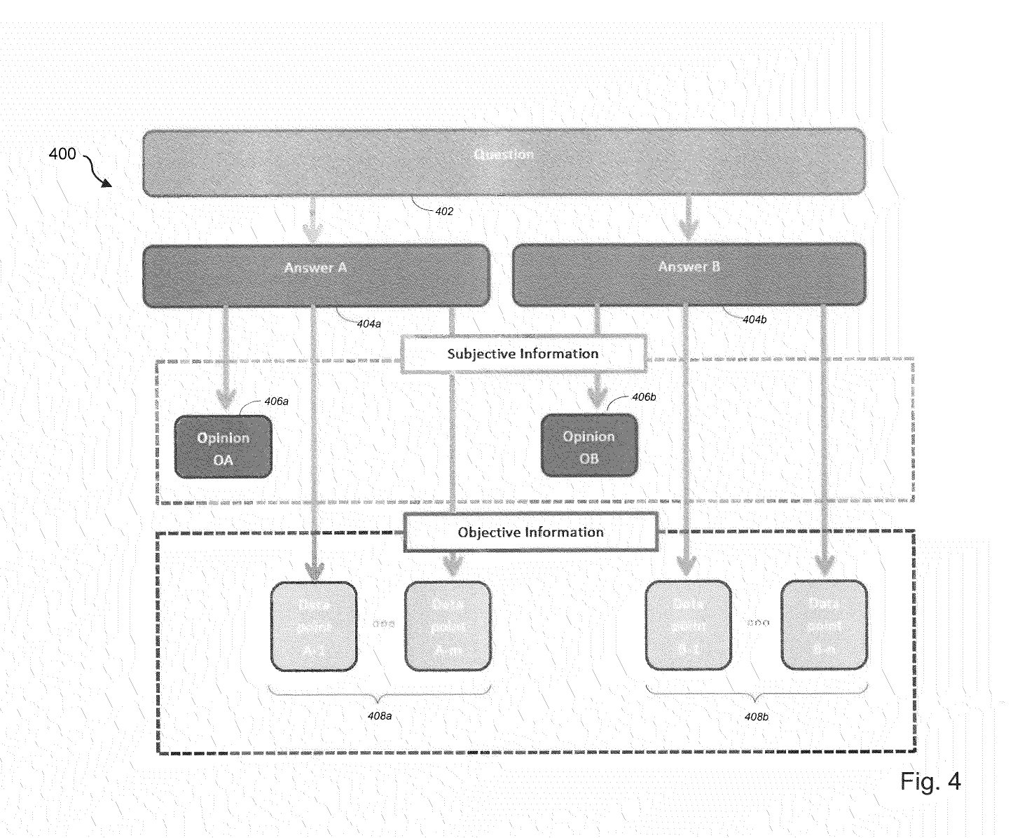

FIG. 4 illustrates a data structure 400 representing a particular poll question 402 and the supplemental data associated with the question 402. As shown, the question 402 has two available responses 404a, 404b. Each response has subjective information including an opinion 406a, 406b, and objective information including data points 408a, 408b.

The data structure 400 may be used to serve a comprehensive poll in accordance with various implementations of the present invention. In some implementations, the format of the poll generated by the data structure 400 may differ according to the environment in which the poll has to be served. In some implementations, less than all of the supplemental data may be provided along with the question 402 and answers 404a, 404b. In some implementations, the supplemental data may include summaries that can be included in place of the full supplemental data; where a summary is delivered in place of the full supplemental data, a link or other reference may be provided to the user so that the full supplemental data can be reviewed at the user's option.

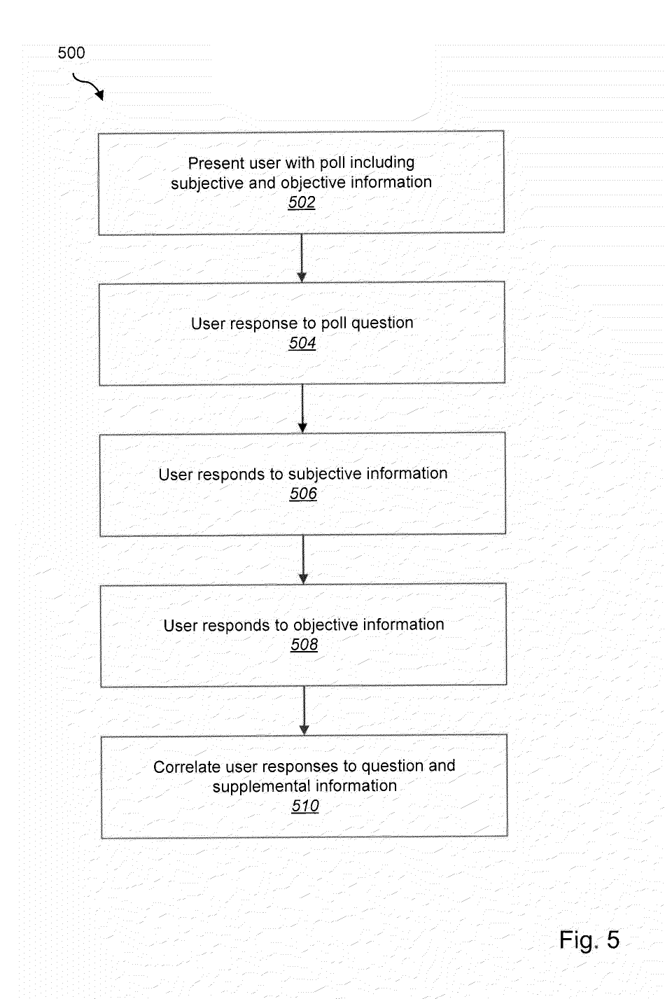

FIG. 5 is a flow chart illustrating a method 500 for presenting a structured poll in accordance with embodiments of the present invention.

A user is presented with a structured poll, which includes supplemental information including both subjective and objective information (502). As described herein, this may include expert reports, comments from users, and curated facts and articles which are understood to support one of the possible responses to the poll questions. Each of the responses (other than, perhaps, a neutral response such as “I don't know” or “unsure”) may have at least some supporting information.

The user responds to the poll question (504). This may involve choosing from the available responses, but it will be understood that a “response” may also include other behavior as known in the surveying art. Failing to choose an available response, plus any ancillary behavior such as closing a window associated with the poll, may also be tabulated in some implementations.

In addition to responding to the poll question, the user also responds to the subjective information (506). A “response” may include voting for or against a particular piece of subjective information, but may also include following a link to further information, “sharing” an opinion on social media, or writing a reply to a particular opinion. Similarly, the user response to the objective information (508) may be voting for or against it, sharing it, choosing to follow references to learn more about it, or addressing it in some way.

After the user has responded the poll and the supplemental information, the system correlates the user responses both to the poll itself and to the supplemental information (510). This allows for multi-variable analysis and may allow the user's response to be characterized as more than just a vote for one side or the other. By correlating the user's primary and supplemental responses, more robust and nuanced data is generated by the poll.

At this point it should be noted that techniques in accordance with the present disclosure as described above may involve the processing of input data and the generation of output data to some extent. This input data processing and output data generation may be implemented in hardware or software. For example, specific electronic components may be employed in circuitry for implementing the functions in accordance with the present disclosure as described above. Alternatively, one or more processors operating in accordance with instructions may implement the functions in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The logic to conduct this invention is delivered as software modules. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

1. A computer-implemented method, comprising:
presenting users with a poll, the poll comprising:
a plurality of poll options, with the ability for the user to vote for at least one of the poll options,
one or more objective information sources associated with the poll options, with the ability for the user to provide an evaluation of each of the one or more objective information sources, and
one or more subjective information sources associated with the poll options, with the ability for the user to provide an evaluation of each of the one or more subjective information sources; and
aggregating the users' votes of the poll options, the users' evaluations of the one or more objective information sources, and the user's votes of the one or more subjective information sources to generate multi-dimensional poll results.

2. The computer-implemented method of claim 1, further comprising:
categorizing the poll results based on whether the users' votes correlate with their evaluation of the objective and subjective information sources.

3. The computer-implemented method of claim 1, wherein the one or more objective information sources includes, for each of the poll options, an associated piece of numerical or narrative data that supports the poll option.

4. The computer-implemented method of claim 3, wherein the user is presented the option of voting for each of the pieces of data.

5. The computer implemented method of claim 4, wherein the presentation of each of the pieces of numerical or narrative data includes a total number of times that the piece of data has been voted for.

6. The computer-implemented method of claim 1, wherein the one or more subjective information sources includes, for each of the poll options, an associated expert opinion that supports the poll option.

7. The computer-implemented method of claim 6, wherein the user is presented the option of voting either for or against each of the expert opinions.

8. The computer-implemented method of claim 7, wherein the presentation of each of the expert opinions includes a total number of times that the expert opinion has been voted for and the total number of times that the expert opinion has been voted against.

9. A computer-implemented method, comprising:
presenting users with a poll, the poll comprising:
a plurality of poll options, with the ability for the user to vote for at least one of the poll options, and
one or more information sources associated with the poll options, with the ability for the user to provide an evaluation of each of the one or more information sources; and
aggregating both the users' votes of the poll options and the users' evaluations of the one or more information sources, to generate multi-dimensional results.

10. The computer-implemented method of claim 9, further comprising:
categorizing the poll results based on whether the users' votes correlate with their evaluation of the one or more information sources.

11. The computer-implemented method of claim 9, wherein the one or more information sources includes, for each of the poll options, an associated piece of numerical or narrative data that supports the poll option.

12. The computer-implemented method of claim 9, wherein the one or more information sources includes, for each of the poll options, an associated expert opinion that supports the poll option.

13. The computer-implemented method of claim 9, wherein the user is presented the option of voting for each of the one or more information sources.

14. The computer-implemented method of claim 9, wherein the user is presented the option of voting either for or against each of the one or more information sources.

15. The computer-implemented method of claim 9, wherein the presentation of each of the one or more information sources includes a score representing an aggregate evaluation of the information sources by users taking the poll.

16. The computer-implemented method of claim 1,
wherein the poll is generated from a data structure including the plurality of poll options and supplemental data associated with each of the poll options; and
wherein fewer than all of the supplemental data associated with each of the poll options is presented as the one or more information sources.

17. The computer-implemented method of claim 16, wherein the poll includes a reference to the supplemental data that is not presented in the poll.

18. At least one non-transitory processor readable storage medium storing a computer program of instructions configured to be readable by at least one processor for instructing the at least one processor to execute a computer process for performing the method as recited in claim 9.

19. A system comprising:
one or more processors communicatively coupled to a network; wherein the one or more processors are configured to:
present users with a poll, the poll comprising:
a plurality of poll options, with the ability for the user to vote for at least one of the poll options, and
one or more information sources associated with the poll options, with the ability for the user to provide an evaluation of each of the one or more information sources; and
aggregate both the users' votes of the poll options and the users' evaluations of the one or more information sources, to generate multi-dimensional results.

20. The system of claim 19, wherein the processors are further configured to:
categorize the poll results based on whether the users' votes correlate with their evaluation of the one or more information sources.
